(19) United States
(12) Patent Application Publication
(10) Pub. No.: US 2011/0038688 A1
(43) Pub. Date: Feb. 17, 2011

(54) BLIND INSTALLED EXPANDABLE COLLAR AND THREADED INNER MEMBER

(75) Inventors: Timothy Howard Johnson, Seattle, WA (US); James Ryunoshin Ross, Seattle, WA (US); Leonard Frederick Reid, Issaquah, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Fatigue Technology ,Inc. a corporation

(21) Appl. No.: 12/446,205

(22) PCT Filed: May 15, 2008
(86) PCT No.: PCT/US2008/063785

§ 371 Date: Nov. 1, 2010

Related U.S. Application Data
(60) Provisional application No. 60/930,598, filed on May 15, 2007.

(51) Int. Cl. F16B 21/00; B23P 17/04

(52) U.S. Cl. 411/357; 29/505; 411/511

(57) ABSTRACT

An expandable kit (110) that includes an inner member (114), an outer collar (116), and an expandable member (112). The expandable member can be used to cold work an opening of a workpiece (130) and induce expansion of the outer collar in order to retain the outer collar. A method of installing the kit that includes passing a tapered portion of a mandrel through the expandable member to radially expand the expandable member into the structural workpiece. The outer collar is moved axially over the expandable member until the workpiece is compressed or captured between the expanded portion of the outer collar and a retaining end of the expandable member. The inner member is pulled into the expandable member.

### CROSS-REFERENCE TO RELATED APPLICATION

This application claims the benefit under 35 U.S.C. §119(e) of U.S. Provisional Patent Application No. 60/930,598 filed May 15, 2007, which is incorporated herein by reference in its entirety.

### BACKGROUND OF THE INVENTION

1. Field of the Disclosure

This disclosure generally relates to expandable kits and methods of using the same for blind installations.

2. Description of the Related Art

Threaded elements for retaining screws are often installed into a wall. A blind threaded element can be installed in seconds into an opening in a wall without backside access. Such installed threaded elements can be configured to receive an externally threaded component, for example a bolt or a screw.

U.S. Pat. No. 6,990,722 discloses one type of a blind threaded element having a collapsible portion for forming a flange. These types of threaded elements may not withstand high axial tensile loads and high torques because the elements are made of materials suitable for undergoing a collapsing process. Internal threads of the threaded element made of these types of materials may not be strong enough to withstand extremely high loads and, consequently, may result in unwanted pull-outs. Additionally, flanges of the installed threaded elements can continue to collapse, especially under high cyclic loading. This further collapsing can reduce any tensile pre-load in a screw attached to the threaded element, thereby allowing securing nuts to back off and reduce clamp-up forces in the secured wall.

Threaded elements may also cause damage to a wall, especially a wall made of composite materials. During the collapsing process, the collapsed flange on the backside of the wall may crush or otherwise damage the surface layers (i.e., surface layers on the backside of the wall) of composite material around the opening in which the threaded element is installed. The collapsed flange may also produce relatively high non-uniform contact stresses on the backside surface of the wall. Wall damage due to crushing or high contact stresses can significantly reduce performance of the wall. Thus, known threaded elements may be unsuitable for use in many types of structures and load conditions.

### BRIEF SUMMARY OF THE DISCLOSURE

Some embodiments disclosed herein include a bushing kit having a threaded inner member that can be installed in an opening of a workpiece. The installed threaded inner member can resist a wide range of static or dynamic loads. A radially-expanded bushing and a radially-expanded collar cooperate to retain the threaded inner member while minimizing, limiting, or substantially eliminating unwanted damage to the workpiece. The installed bushing kit provides strong internal threads for receiving an externally threaded fastener and high levels of applied expansion in a variety of workpieces.

The threaded inner member can be an internally threaded nut suitable for threadably receiving a threaded fastener. The threaded inner member can be formed, in whole or in part, of a strong material (e.g., hardened stainless steel) for strong threads that resist pullouts.

The collar can be an expandable tubular member that is expanded with the radially-expanded bushing. As used herein, the term “expandable” and variations thereof (e.g., expanded) are broad terms and include, but are not limited to, spreading, swaging, drawing, radially expanding, deforming, or other means of displacing at least a portion of a component. For example, an expandable tubular collar can be deformed when drawn over a portion of the bushing protruding from a workpiece. Unlike a split collar, the tubular collar can form a high interference fit with the bushing.

The radially-expanded bushing may achieve high levels of expansion in the workpiece to improve fatigue performance of the workpiece. In some embodiments, the collar is captured between the threaded inner member and the workpiece such that the bushing extends through the collar.

In some embodiments, an installation in an opening in a workpiece comprises an inner member, a collar, and an expandable member. The workpiece can comprise a single structural member or a plurality of structural members. The inner member has a shoulder and a receiving portion, which has an outer surface. The collar has a first end, an expanded second end, and a body extending between the first end and the second end. The body defines an inner surface of the collar. The first end of the collar is adjacent the shoulder of the inner member, and the second end of the collar is adjacent the workpiece. The body extends along the receiving portion of the inner member. The expandable member is interposed between the outer surface of the receiving portion and the inner surface of the collar, and comprises an expansion portion, a retaining end, and a body extending between the expansion portion and the retaining end. The expansion portion is dimensioned to radially expand at least the second end of the collar in an initial configuration when the expansion portion travels between the inner surface of the collar and the outer surface of the inner member towards the shoulder such that the workpiece is captured between the expanded second end of the collar on one side of the workpiece and the retaining end of the expandable member on another side of the workpiece.

In some embodiments, a bushing kit for installation in an opening of a workpiece is provided. The bushing kit comprises an inner member having a shoulder and a receiving portion, a collar having a distal end, a proximal end, and a body extending between the distal end and the proximal end, and a bushing. The bushing is dimensioned to be interposed between the receiving portion and the collar when the receiving portion extends through the collar. The bushing comprises an expansion portion, a retaining end, and a body extending between the expansion portion and the retaining end. The expansion portion is dimensioned to radially expand at least the proximal end of the collar when the expansion portion travels between the inner member and the collar towards the shoulder such that the workpiece is captured between the expanded proximal end of the collar and the retaining end of the bushing on the other side of the workpiece.

In some embodiments, a method of installing a bushing kit into an opening in a structural workpiece is provided. The opening extends between a first side and a second side of the workpiece. The method comprises positioning an inner member on the first side of the workpiece. The inner member comprises a receiving portion and a shoulder. The collar is positioned on the first side of the workpiece, and comprises a distal end, a proximal end, and a body extending between the distal end and the proximal end. The body of the collar surrounds the receiving portion of the inner member. The first end of the collar is adjacent to the shoulder of the inner member. An expander end of a bushing is positioned between the body of the collar and the receiving portion of the inner member such that the expander end of the bushing is on the first side of the workpiece and a retaining end of the bushing is on the second side of the workpiece. After the expander end of the bushing is between the body of the collar and the receiving portion of the inner member and while the distal end of the collar abuts the shoulder of the inner member, the expander end of the bushing is moved axially along the collar and the receiving portion of the inner member to radially expand at least the proximal end of the collar until the workpiece is secured between the expanded proximal end of the collar and the retaining end of the bushing.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements may be arbitrarily enlarged and positioned to improve drawing legibility.

FIG. 1 is a side elevational view of an installation system having a mandrel attached to an installation tool and an expandable kit positioned on the mandrel and ready for installation, according to one illustrated embodiment.

FIG. 2 is a side elevational view of the installation system of FIG. 1 after the expandable kit is installed.

FIG. 3 is a detailed partial cross-sectional view of the installed kit of FIG. 2 taken along 3-3.

FIG. 4 is a cross-sectional view of an installed kit comprising an inner member, a collar, and an expandable member, according to one illustrated embodiment.

FIG. 5 is an isometric cross-sectional view of the installed kit of FIG. 4.

FIG. 6 is an isometric view of an expandable member, according to one illustrated embodiment.

FIG. 7 is a plan view of the expandable member of FIG. 6.

FIG. 8 is a cross-sectional view of the expandable member of FIG. 7 taken along the line 8-8.

FIG. 9 is a detailed cross-sectional view of a portion of the expandable member, according to one illustrated embodiment.

FIG. 10 is an isometric view of an inner member, according to one illustrated embodiment.

FIG. 11 is a plan view of the inner member of FIG. 10.

FIG. 12 is a cross-sectional view of the inner member of FIG. 11 taken along the line 12-12.

FIG. 13 is an isometric view of a collar, according to one illustrated embodiment.

FIG. 14 is a plan view of the collar of FIG. 13.

FIG. 15 is a cross-sectional view of the collar of FIG. 14 taken along the line 15-15.

FIG. 16 is a side elevational view of a mandrel for installing an expandable kit, according to one illustrated embodiment.

FIG. 17 is a side elevational view of an expandable kit being placed on a mandrel, according to one illustrated embodiment.

FIG. 18 is a side elevational view of the expandable kit positioned on the mandrel and ready to be placed in the workpiece for installation.

FIG. 19 is a cross-sectional view of the mandrel and expandable kit, wherein an installation tool is operating to install an expandable member of the kit into an opening of a structural workpiece using the mandrel, according to one illustrated embodiment.

FIG. 20 is a cross-sectional view of the mandrel and the kit showing a collar spreading outwardly over the expanded expandable member of the kit.

FIG. 21 is a cross-sectional view of the mandrel and the installed expandable kit.

FIG. 22 is a cross-sectional view of the installed expandable kit after the mandrel has been removed and a fastener positioned for installation.

FIG. 23 shows a fastener coupled to the installed expandable kit.

FIG. 24 is a graph showing radial strain in a structural workpiece due to cold expansion of an expandable member, without an inner member installed.

FIG. 25 is a graph showing radial strain in the structural workpiece due to cold expansion of the expandable member before and after a thick-walled inner member has been installed.

FIG. 26 is an isometric cross-sectional view of an installed expandable kit, according to one illustrated embodiment.

FIG. 27 is an isometric cross-sectional view of an installed expandable kit, according to one illustrated embodiment.

FIG. 28 is an isometric cross-sectional view of an installed expandable kit having a closed-ended inner member, according to one illustrated embodiment.

FIG. 29 is an isometric cross-sectional view of an installed expandable kit having a two-piece inner member, according to one illustrated embodiment.

FIG. 30 is a partial cross-sectional view of an expandable kit and an installation stud, according to one illustrated embodiment.

FIG. 31 is an isometric cross-sectional view of the expandable kit of FIG. 30 installed in a workpiece, according to one illustrated embodiment.

FIG. 32 is an isometric cross-sectional view of an expandable kit and a threaded stud coupled to the kit.

### DETAILED DESCRIPTION OF THE DISCLOSURE

In the following description, certain specific details are set forth in order to provide a thorough understanding of various embodiments of the invention. However, one skilled in the art will understand that embodiments of the invention may be practiced without these details. The kits and processes disclosed herein can be used to repair damaged workpieces and, in some embodiments, may improve fatigue performance of the workpiece. The expandable kits can be installed in damaged workpiece holes to improve fatigue performance. In multi-piece workpieces (e.g., laminates, joints, a stack of plates), the expandable kits can be installed in discrepant fastener holes, loose joints, and the like. The kits can be used to couple fasteners, studs, or other types of components to a workpiece. The terms “proximal” and “distal” are used to describe the illustrated embodiments and are used consistently with the description of non-limiting exemplary applications. The terms proximal and distal are used in reference to the user's body when the user operates an installation tool, unless the context clearly indicates otherwise.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the claims, the singular forms “a,” “an,” and “the” include plural referents unless the context clearly dictates otherwise. Thus, for example, reference to an expandable member that includes “a flange” includes an expandable member with a single flange or an expandable member with two or more flanges, or both. It should also be noted that the term “or” is generally employed in its sense including “and/or” unless the context clearly dictates otherwise.

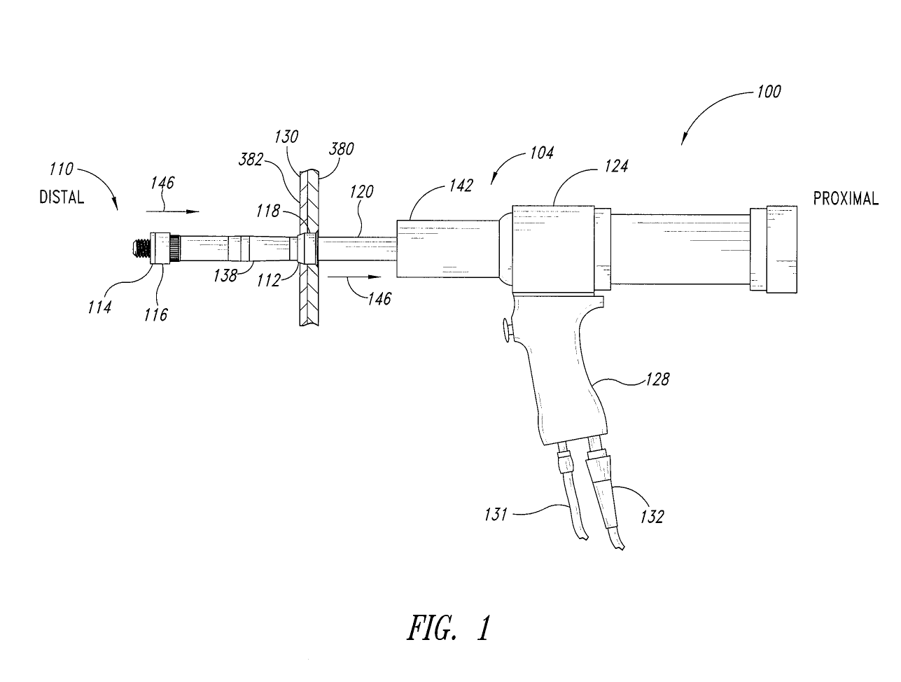

FIG. 1 shows an installation system 100 which includes an installation tool 104 and an expansion mandrel 120 extending outwardly from the installation tool 104. The installation system 100 can be used to install an expandable kit 110, which includes an expandable member 112, an inner member 114, and an outer collar 116 positioned on the inner member 114.

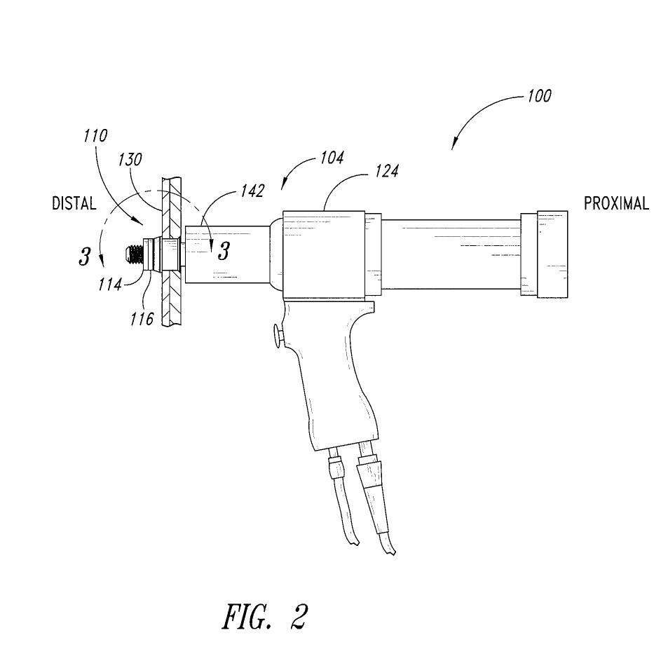

The illustrated expandable member 112 is in an opening 118 in a workpiece 130. To install the expandable kit 110, a nose cap 142 of the installation tool 104 is placed against the expandable member 112, the workpiece 130, or both. The expansion mandrel 120 is pulled through the expandable member 112 (indicated by the arrow 146) to expand the expandable member 112. The expanded expandable member 112 is then assembled with the pre-assembled outer collar 116 and inner member 114. FIGS. 2 and 3 show the kit 110 after the expansion mandrel 120 has been retracted into the installation tool 104. As shown in FIGS. 2 and 3, at least a portion of the outer collar 116 is expanded and extends over the expandable member 112 and, in some embodiments, forms a permanent interference fit with the expandable member 112. The outer collar 116 and expandable member 112 cooperate to retain the inner member 114 such that another component (e.g., a fastener, rod, stud, or the like) can be coupled to the inner member 114 and held stationary with respect to the workpiece 130.

Referring again to FIG. 1, the installation tool 104 includes a main body 124 that is coupled to a grip 128. The user can manually grasp the grip 128 to comfortably hold and accurately position the installation system 100. The illustrated grip 128 is a pistol grip; however, other types of grips can be utilized.

The installation tool 104 can be driven electrically, hydraulically, pneumatically, or by any other suitable drive means. In some embodiments, the main body 124 houses a mechanical drive system that can drive the expansion mandrel 120, preferably along a predetermined path (e.g., a line of action) in a proximal direction, towards the installer, and/or a distal direction, away from the installer. In the illustrated embodiment, a pair of fluid lines 131, 132 provides pressurized fluid (e.g., pressurized gas, liquid, or combinations thereof) to a piston drive system that actuates the expansion mandrel 120. One of ordinary skill in the art can select the type of drive system used to achieve the desired motion of the mandrel 120.

The expansion mandrel 120 is configured to radially expand the expandable member 112 when the mandrel 120 is moved axially through a passageway in the expandable member 112. The mandrel 120 pulls the assembled inner member 114 and outer collar 116 into engagement with the expanded expandable member 112. As used herein, the term “mandrel” is a broad term and includes, but is not limited to, an elongated member having at least one tapered portion or expanded portion used to expand an expandable member or other component. The illustrated expansion mandrel 120 includes a gradually tapered portion 138 used to radially expand the expandable member 112 in order to produce an interference fit between the expandable member 112 and the workpiece 130. Mandrels can have a one-piece or multi-piece construction.

As used herein, the term “expandable member” is a broad term and includes, but is not limited to, a bushing, washer, sleeve (including a split sleeve), fitting, fastener, structural expandable member (e.g., expandable members that are incorporated into structural workpieces), or other structure that is suitable for coupling to a workpiece. Expandable members can be expanded from a first configuration to a second configuration. In some embodiments, for example, the expandable member is a bushing that is radially expanded from an initial configuration to a second configuration in order to form an interference fit with a through-hole in a workpiece. The term “expandable member” refers to a member both in a pre-expanded state and post-expanded state, unless the context clearly dictates otherwise. Various types of expansion processes can be employed to expand the expandable members. In a cold expansion process, for example, the expandable member is radially expanded without appreciably raising the temperature of the expandable member to produce residual stresses in the workpiece to enhance fatigue performance. The residual stresses are preferably compressive stresses that can minimize, limit, inhibit, or prevent crack initiation and/or crack propagation. The illustrated expandable member 112 of FIG. 1 is in the form of a bushing capable of generating residual stresses.

The kit 110 can be installed in various types of workpieces. The term “workpiece” is broadly construed to include, without limitation, a parent structure having at least one hole or opening suitable for receiving at least one component of the kit 110. The opening 118 can be a through-hole (with or without back side access), blind hole, or other type of hole. In some embodiments, the kit 110 can be installed in a structural workpiece, such as a bulkhead, fuselage, engine, or other structural member of an aircraft. If the workpiece 130 is a multi-piece structure, the kit 110 can hold the pieces of the structure together with a desired clamp-up force.

The illustrated workpiece 130 of FIG. 1 preferably has sufficient mechanical properties such that the installation system 100 can install the expandable member 112 while the member 112 is positioned within the hole 118 of the workpiece. The pre-assembled inner member 114 and outer collar 116 can be coupled to the installed expanded member 112. The structural workpiece 130 can comprise one or more metals (e.g., steel, aluminum, titanium, and the like), polymers, plastics, composites, or other materials suitable for engaging one or more of the components of the kit 110.

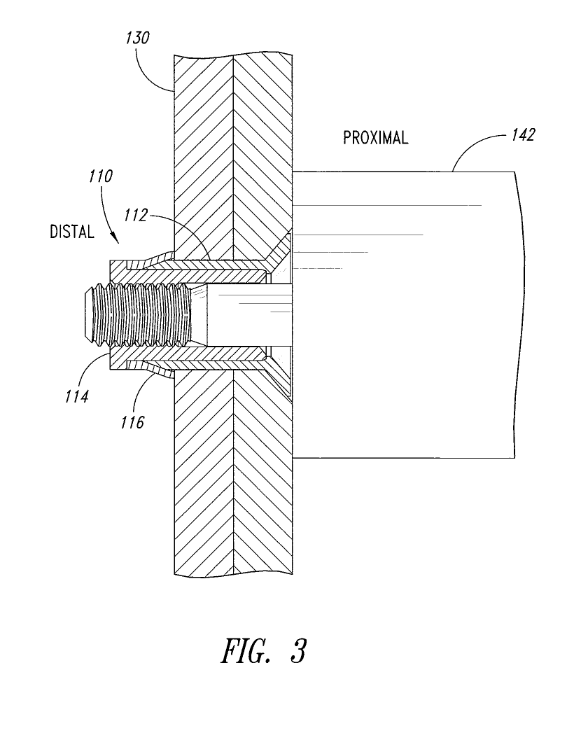

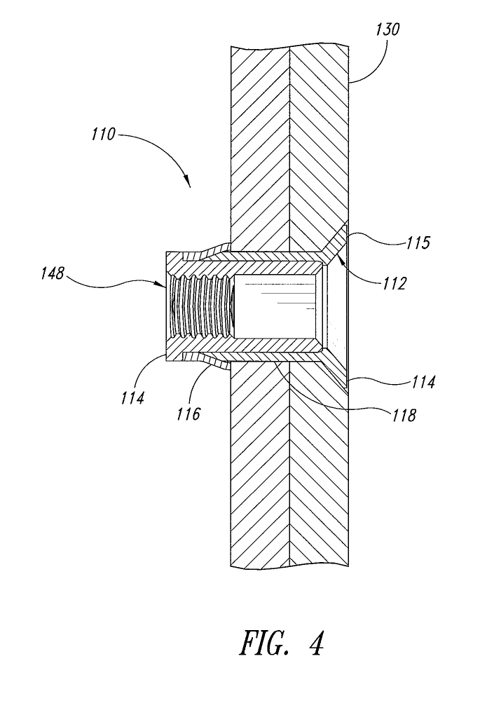

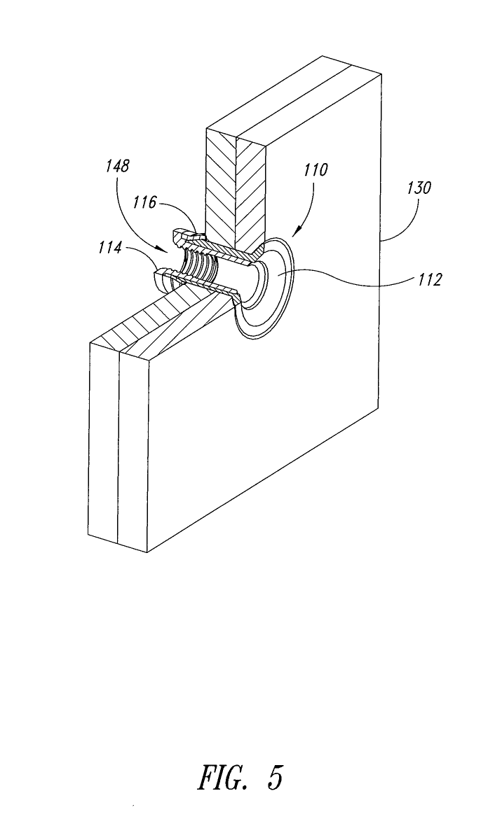

FIGS. 4 and 5 show the installation 110 ready to receive another component after the expansion mandrel 120 has been removed. The expanded member 112 is between the partially-expanded outer collar 116 and the inner member 114. The material of the workpiece 130 surrounding the opening 118 is captured between the outer collar 116 and a retaining end 115 of the expandable member 112. The outer collar 116 can be translationally and/or rotationally fixed with respect to the expandable member 112 because of localized spreading of the outer collar 116 caused by the expandable member 112. The expandable member 112, in turn, can be translationally and/or rotationally fixed with respect to the workpiece 130 due to compressive stresses developed in the workpiece 130 when the member 112 is radially expanded. The compressive stresses, for example, can be developed when the mandrel 120 expands the expandable member 112 from the initial configuration (see FIG. 1) to the expanded configuration (see FIG. 2). The inner member 114 can be translationally and/or rotationally fixed with respect to the installed member 112 because of the member 112 contracting about the inner member 114. Thus, each of the components of the kit 110 can be fixedly coupled directly or indirectly to the workpiece 130.

In some embodiments, the installed expandable member 112 inhibits, limits, or substantially eliminates relative movement of the inner member 114, even if another component coupled to the inner member 114 is subjected to various loading conditions, including static and cyclic axial loading. Various types of components, including, without limitation, fasteners, rods (e.g., threaded rods), bolts, studs, and the like can be temporarily or permanently coupled to the installation 110 via the inner member 114. The illustrated inner member 114 has an engagement portion 148 (illustrated as internal threads) for threadably coupling with an externally threaded screw that can increase clamp-up forces.

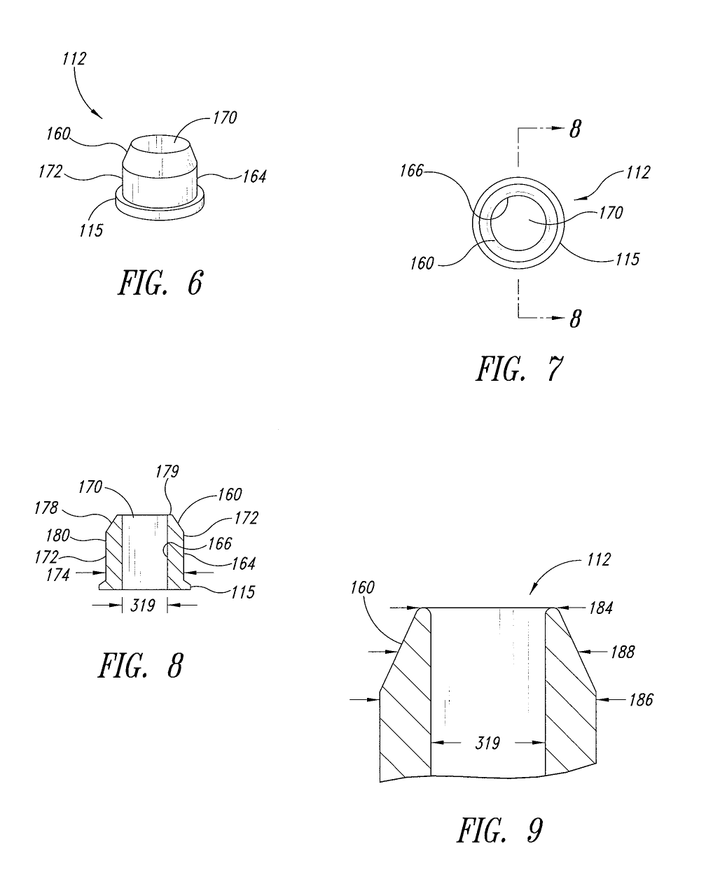

FIGS. 6 to 9 show the expandable member 112 that includes an expansion portion 160, the retaining end 115, and a body 164 extending between the expansion portion 160 and the retaining end 115. The expandable member 112 further includes an inner surface 166 defining a passageway 170 and an outer surface 172. The outer surface 172 includes an outer perimeter 174 sized to closely fit (e.g., a clearance fit with a minimal amount of clearance) within the opening 118 of the workpiece 130. Such expandable member 112 can be easily inserted into the opening 118 and then expanded for a desired fit, as detailed further below.

The expansion portion 160 is dimensioned to radially expand or spread at least a portion of the outer collar 116 when the expansion portion 160 is wedged between the inner member 114 and the outer collar 116. The illustrated expansion portion 160 is a circumferential angled chamfer defining a generally frusto-conical surface 178 of the outer surface 172. The surface 178 extends from a leading edge 179 to a uniform section 180, which extends between the frusto-conical surface 178 and the retaining end 115. The leading edge 179 can be small enough to conveniently fit between the pre-assembled inner member 114 and outer collar 116.

The retaining end 115 can be configured to reduce, limit, or substantially eliminate movement of the expandable member 112 with respect to the workpiece 130. The illustrated retaining end 115 is in the form of a chamfered annular radial flange for seating against the workpiece 130. The retaining end 115, in some embodiments, can include one or more outwardly extending stops, tabs, or other features suitable for reducing, limiting, or substantially eliminating unwanted movement of the expandable member 112. Based on the type of component coupled to the inner member 114, the configuration of the retaining end 115 can be selected to achieve the desired fit and to withstand anticipated pull-out forces. Additionally, the retaining end 115 can be countersunk in order to receive a head of a fastener. Other types of retaining ends can also be employed, if needed or desired.

In some embodiments, including the illustrated embodiment of FIG. 9, the expansion portion 160 includes a minimum perimeter 184, a maximum perimeter 186, and a transition perimeter 188 extending therebetween. The transition perimeter 188 can increase, uniformly or non-uniformly, between the minimum perimeter 184 and the maximum perimeter 186. For example, the expansion portion 160 can be a chamfer with an angled surface and a selected slope or curvature for a desired amount and rate of expansion of the outer collar 116. In some embodiments, the expansion portion 160 is sized to permit the outer collar 116 to slide smoothly along the surface 178 until the outer collar 116 is radially expanded a desired amount.

The expandable member 112 may be made from a wide variety of materials that permit the radial expansion and contraction. The expandable member 112 can be made, in whole or in part, of metal that experiences plastic deformation to form a permanent interference fit with the workpiece 130 and elastic deformation to contract onto and form a permanent interference fit with the inner member 114.

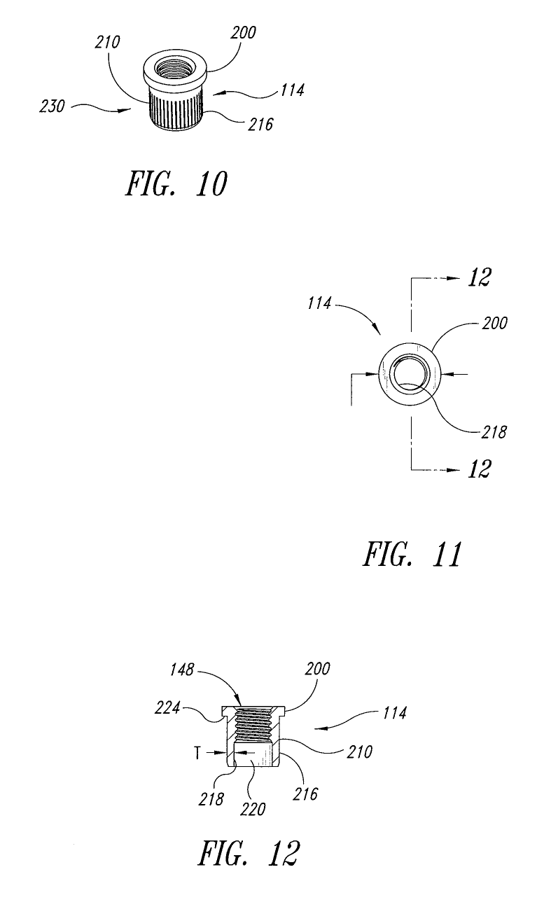

FIGS. 10-12 illustrate the inner member 114 having a shoulder 200 for contacting the outer collar 116 and a receiving portion 210 for fitting into the expandable member 112. The receiving portion 210 defines an outer surface 216 and an inner surface 218. The inner surface 218 defines a passageway 220 (illustrated as a through-hole) and the engagement portion 148.

The shoulder 200 can serve as a stop to inhibit or limit relative movement between the outer collar 116 and the inner member 114. The term “shoulder” as used herein is broadly construed to include, without limitation, at least one feature suitable for limiting or inhibiting movement of the outer collar 116 during the installation process. In some embodiments, the shoulder 200 comprises one or more stops, projections (e.g., outwardly extends protuberances), flanges, steps, welds, or combinations thereof. The illustrated shoulder 200 of FIG. 12 is in the form of a radial flange having an annular face 224 for contacting and pushing the outer collar 116 over the expandable member 112.

The receiving portion 210 projects axially from the shoulder 200 and has the outer surface 216 for conforming closely to the outer collar 116 and/or the expandable member 112. The shape and dimensions of the receiving portion 210 can therefore be selected based on the design of the outer collar 116 and/or expandable member 112.

FIG. 10 shows a plurality of fixation features 230 extending longitudinally along the outer surface 216. The fixation features 230 can be grooves, slots, texturing, or other types of features suitable for reducing relative movement between the inner member 114 and the outer collar 116 and/or between the inner member 114 and the expandable member 112. In some embodiments, for example, the outer surface 216 is knurled to increase frictional interaction. In some embodiments, the outer surface 216 may not include any fixation features, especially if the compressive forces between components of the kit 110 are sufficient to substantially prevent unwanted movement of those components.

The engagement portion 148 of FIG. 12 includes a plurality of internal threads configured to engage and retain an externally threaded component. Additionally or alternatively, the inner member 114 can have one or more setscrews, bonding agents or adhesives, locking features, or the like used to retain another component placed in the inner member 114.

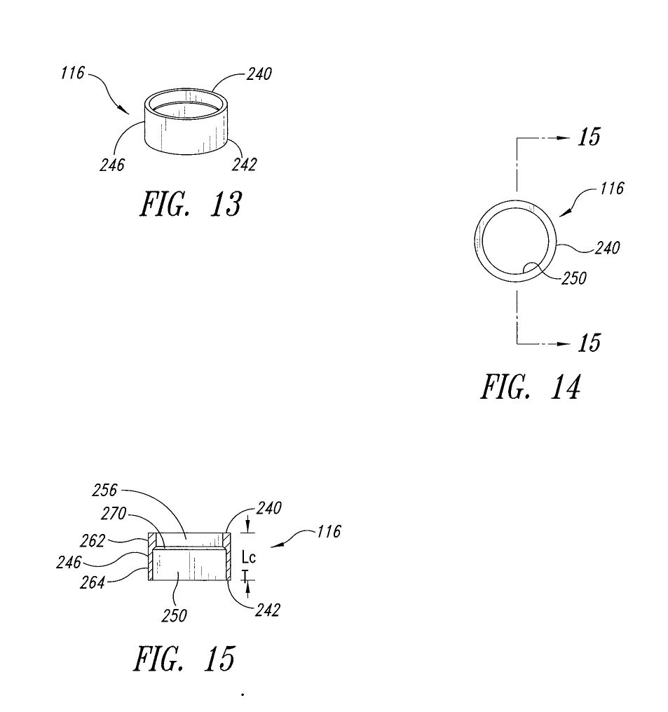

With reference to FIGS. 13-15, the outer collar 116 includes a distal end 240, a proximal end 242, and a body 246 extending between the distal end 240 and the proximal end 242. The body 246 has an inner surface 250, which defines a passageway 256 and is configured to conform to the receiving portion 210. A length L_{c} of the outer collar 116 is selected to be larger than a length of the portion of the installed expandable member 112 protruding from the workpiece 130. In such embodiments, the distal end 240 of the outer collar 116 can surround the receiving portion 210 adjacent the shoulder 200 while the proximal end 242 of the outer collar 116 cams over the expansion portion 160 of the expandable member 112.

The inner surface 250 of the outer collar 116 can include a reduced perimeter section 262 for engaging the receiving portion 210 and an enlarged perimeter section 264 for facilitating movement over the expandable member 112. A stepped or chamfered region 270 is positioned between the reduced perimeter section 262 and the enlarged perimeter section 264. Other types of collars can also be used. For example, the outer collar 116 can be a tubular member having a passageway with a uniform perimeter.

The outer collar 116 may be made from a wide variety of materials that permit expansion (e.g., cold expansion) of at least the proximal end 242from an initial configuration to an expanded configuration using the expandable member 112. The expanded proximal end 242 can then radially contract (e.g., elastically contact) onto the expandable member 112 to reduce, limit, or substantially eliminate movement with respect to the expandable member 112, as shown in FIG. 3. Thus, the material selected for making the outer collar 116 can experience both plastic deformation and elastic deformation.

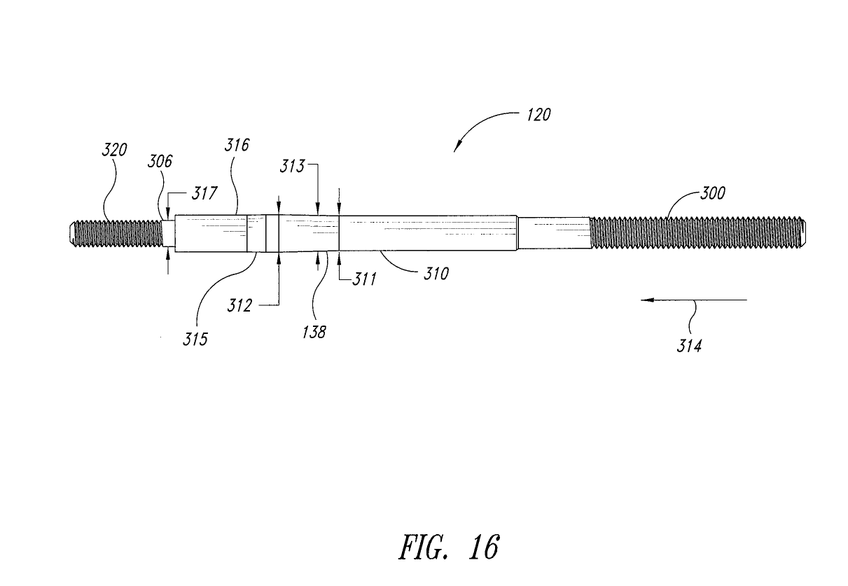

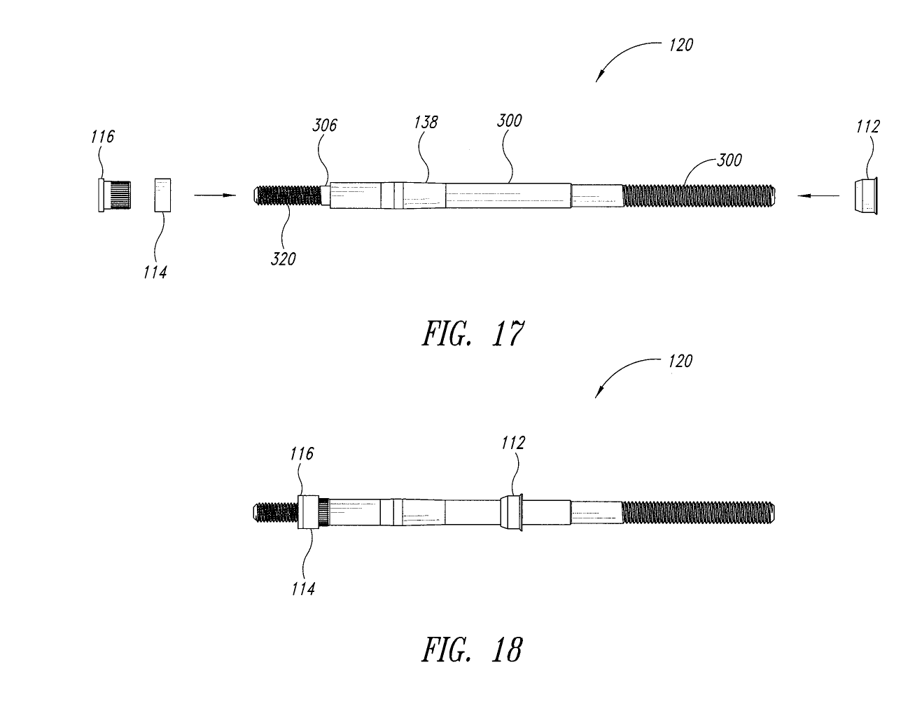

FIG. 16 shows the expansion mandrel 120 including an engagement region 300, a tapered region 138, a carrying region 306, and a loading region 320. The mandrel 120 further includes a mandrel central body 310 extending between the tapered region 138 and the engagement region 300. In general, the engagement region 300 is configured to connect to an installation or puller tool. As shown in FIG. 17, the expandable member 112 can be slid over the engagement region 300. The pre-assembled inner member 114 and outer collar 116 can be slid over the loading region 320. After the expandable member 112, inner member 114, and outer collar 116 are placed on the mandrel 120 (see FIG. 18), the mandrel 120 is used to sequentially install the expandable member 112 and the assembled inner member 114 and outer collar 116 in the workpiece 130.

With reference again to FIG. 16, the tapered region 138 includes a minimum perimeter portion 311, a maximum perimeter portion 312, and a transition perimeter portion 313 extending therebetween. The tapered region 138 is positioned downstream, as indicated by the arrow 314, from the engagement region 300 and operates to radially expand the expandable member 112. Accordingly, the maximum perimeter portion 312 of the mandrel 120 is at least slightly larger than the inner perimeter 319 of the expandable member 112 (see FIG. 9). For example, the maximum perimeter portion 312 can be a diameter that is larger than the diameter 319 of the expandable member 112.

A tapered down portion 315 can be positioned between the maximum diameter 312 and a uniform perimeter region 316. The tapered down portion 315 tapers from the maximum perimeter portion 312 to the uniform perimeter portion 316. After the maximum perimeter portion 312 expands the expandable member 112, the expanded member 112 can slide over the tapered down portion 315.

The uniform perimeter portion 316 is adjacent to the tapered down portion 315. In some embodiments, the mandrel 120 may not have a uniform perimeter portion in order to reduce the longitudinal length of the mandrel 120. The maximum perimeter portion 312, for example, may be immediately adjacent the carrying region 306.

The carrying region 306 of FIG. 16 includes an outer perimeter 317 sized to receive the inner member 114. For example, the outer perimeter 317 can be sized to receive (e.g., loosely receive with a clearance fit) the inner member 114 so as to minimize, limit, or substantially prevent damage to the inner surface 218 of the inner member 114. The illustrated outer perimeter 317 is smaller than the maximum perimeter portion 312 of the tapered region 138. Other configurations of carrying regions are also possible.

Various modifications can be made to the illustrated mandrel 120 to achieve the desired installation. For example, the transition region 315 and tapered region 138 can be altered or removed to increase interference between the expandable member 112 and the inner member 114. The expandable member 112 can spring back after expansion to form a high interference fit with the inner member 114.

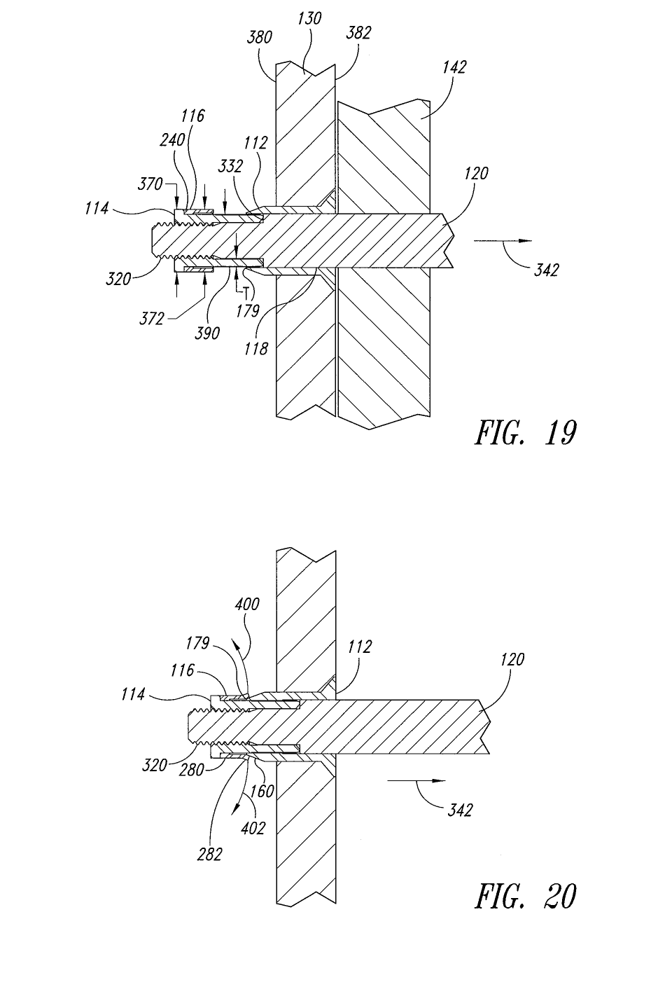

FIG. 19 shows the expanded expandable member 112 ready to cam over a shoulder 332 of the mandrel 120 and onto the inner member 114. The shape, size, and position of the shoulder 332 can be selected based on the desired interaction between the expandable member 112 and both the inner member 114 and the outer collar 116. For example, the shoulder 332 can be configured to position the leading edge 179 of the expandable member 112 between inner member 114 and the outer collar 116. As the mandrel 120 is moved through the expandable member 112, as indicated by the arrow 342, the inner member 114 is pulled into the stationary expandable member 112. The expandable member 112 conveniently cams over the shoulder 332 and then onto the inner member 114. Because the expandable member 112 is in an expanded configuration, it may contract about the inner member 114 to ensure that the leading edge 179 travels closely to the outer surface 216 of inner member 114.

The height of the shoulder 332 (e.g., the distance between the perimeters 316, 317 shown in FIG. 16) can be selected based on the configuration of the inner member 114 and the installation process. The shoulder 332 can have a height that is generally equal to the wall thickness T of the inner member 114 (see FIG. 12). In some embodiments, at least a portion of the wall thickness T of the inner member 114 is greater than or equal to the height of the shoulder 332. As noted above and further detailed below, these relative sizes permit the inner member 114 to be slid into the radially-expanded expandable member 112 without appreciably altering the inner surface 166 of the expandable member 112.

The illustrated engagement portion 148 of the inner member 114 has internal threads that engage the threaded loading region 320 of the mandrel 120. The internal threads of the region 148 can be rotated about the loading region 320 to adjust the distance between the inner member 114 and the shoulder 332. The inner member 114 may be torqued down to provide at least a slight compression force on the receiving portion 210, depending on the compressive strength capacity of the receiving portion 210. In this manner, the loading region 320 of the mandrel 120 limits or substantially prevents axial movement of the inner member 114.

Referring again to FIG. 19, the inner member 114 can have an outer perimeter 370 and the outer collar 116 can have an outer perimeter 372 that are smaller than the outer perimeter of the opening 118 such that the assembled inner member 114 and outer collar 116 can be inserted into and through the opening 118 for one-side (e.g., blind-side) processing.

In one method of installing the kit 110, the expandable member 112 can undergo radial cold expanding into the opening 118 of the workpiece 130. In general, the inner member 114 and outer collar 116 are pre-positioned on the mandrel 120 to closely follow the tapered portion 138 of the mandrel 120 used to expand the expandable member 112. The inner member 114 is then moved into the radially-expanded expandable member 112 while the outer collar 116 is pulled over the expandable member 112. This method is discussed in further detail below in connection with FIGS. 1 and 19-23. Reference herein has been made to “pulling” the mandrel 120; however, it is appreciated that the mandrel 120 may also be pushed through the structural workpiece 130.

With reference again to FIG. 1, if the opening 118 is a blind opening, the outer collar 116, inner member 114, and mandrel 120 can be inserted through the opening 118 from the second side 382 to the first side 380 of the workpiece 130. If the installer has backside access, the inner member 114 and outer collar 116 can be mounted to the mandrel 120 after the mandrel 120 is positioned through the opening 118. Accordingly, the mandrel 120 may or may not be pre-loaded with the kit 110, based on the type of installation process to be performed.

The expandable member 112 of FIG. 1 in an initial pre-expanded configuration can be positioned in the opening 118 such that the installation tool 104, coupled to the mandrel 120, can be operated to move the mandrel 120 through the expandable member 112 to radially expand the expandable member 112. The mandrel 120 of FIG. 1 is pulled through the workpiece 130 (as indicated by the arrow 146) to expand the expandable member 112.

Advantageously, a selected amount of residual compressive stress is induced into the structural workpiece 130 by the radial expansion of the expandable member 112. The residual compressive stresses may enhance the fatigue life of the structural workpiece 130. The amount of radial expansion of the expandable member 112 is selected to achieve a corresponding amount of residual compressive stress in the workpiece 130 surrounding the expandable member 112. Determining the desired amount of residual compressive stress in the workpiece 130 and the amount of interference fit between the expandable member 112 and both the inner member 114 and outer collar 116 may be an iterative process to achieve specific design goals, for example, installing the kit into a reinforced composite workpiece 130 without damaging the workpiece 130.

This iterative process may involve varying or altering one or more of the components (i.e., the structural workpiece 130, the inner member 114, and/or the expandable member 112) and/or various installation parameters in one or more of the following ways, for example, the material properties, the mandrel pulling force, the component dimensions (e.g., wall thickness), etc.

FIG. 19 shows the kit 110 after the expandable member 112 has been radially expanded in the workpiece 130. The outer perimeter 390 of the receiving portion 210 can be equal to or smaller than the maximum perimeter portion 312 of the tapered region 138 of the mandrel 120. This allows the receiving portion 210 to be inserted into the expanded member 112 with at least a slight clearance fit.

The inner member 114 can be moved into the expandable member 112 before the expandable member 112 has had an opportunity to elastically, radially spring back or contract from its radially expanded state. Hence, as the radially-expanded expandable member 112 does begin to elastically, radially spring back or contract, the radial spring back brings the expandable member 112 into contact with the receiving portion 210 of the inner member 114 to form a permanent interference fit therewith. In this manner, an interference fit can be achieved between the expandable member 112 and the inner member 114.

The mandrel 120 is further moved through the expandable member 112. As shown in FIG. 19, the distal end 240 of the outer collar 116 is adjacent the shoulder 200 of the inner member 114. The expandable member 112 is positioned with respect to the workpiece 130 such that the expansion portion 160 of the member 112 projects outwardly from the opening 118. The retaining end 115 of the expandable member 112 is on the first side 380 of the workpiece 130. The longitudinal length of the expandable member 112 can be selected based on the thickness of the workpiece 130 and the desired distance which the expansion portion 160 projects from the workpiece 130.

As shown in FIGS. 19 and 20, the mandrel 120, inner member 114, and outer collar 116 move towards the workpiece 130 (indicated by the arrow 342) until the leading edge 179 of the expandable member 112 is moved between the proximal end 242 of the outer collar 116 and the inner member 114. A gap can be formed between the inner member 114 and the outer collar 116 to facilitate proper entry of the leading edge 179 and, in some embodiments, may reduce the likelihood of damage to the outer collar 116.

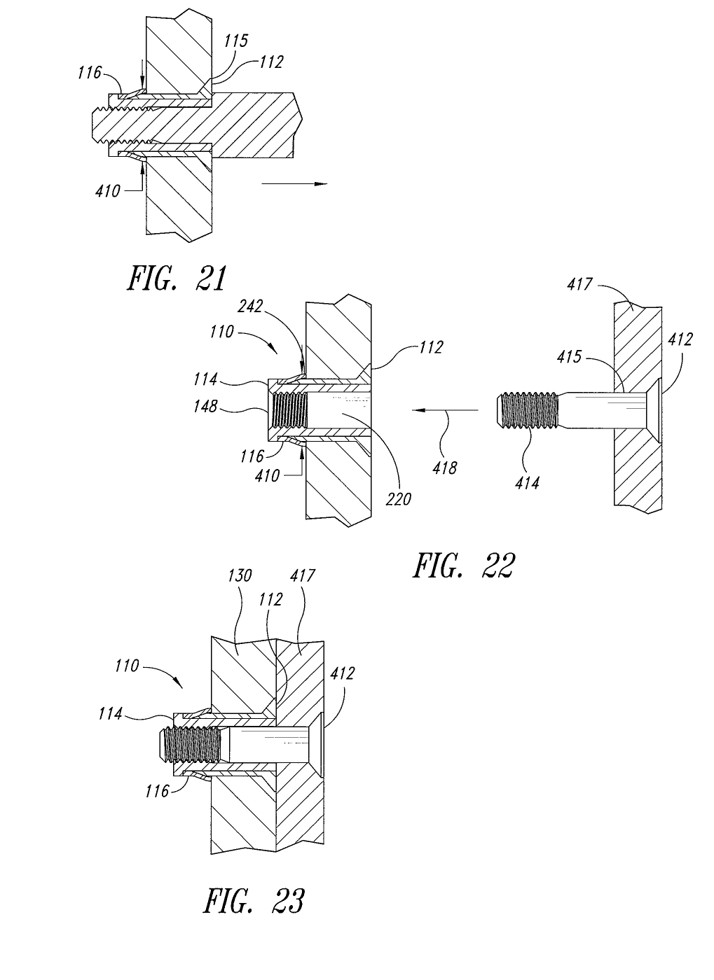

After the expansion portion 160 is between the inner member 114 and outer collar 116, the mandrel 120 is moved further through the expandable member 112 to drive the expansion portion 160 between the outer collar 116 and inner member 114, thereby driving the proximal end 242 of the outer collar 116 outwardly, as indicated by the arrows 400, 402 of FIG. 20. In this manner, the proximal end 242 of the outer collar 116 is expanded or spread outwardly such that at least the proximal end 242 bulges outwardly. The expandable member 112 continues to slide between the outer collar 116 and the inner member 114 until the proximal end 242 of the outer collar 116 is adjacent (e.g., against) the second side 382 of the workpiece 130 (see FIG. 21).

Once the outer collar 116 contacts and applies a desired compressive force to the workpiece 130, movement of the mandrel 120 can be stopped. The workpiece 130 is therefore securely held between the expanded outer collar 116 and the retaining end 115. The mandrel 120 can then be removed from the inner member 114.

FIG. 22 shows the installed kit 110 ready for assembly with another component (illustrated as a threaded fastener 412 and workpiece 417) after removal of the mandrel 120. The illustrated distal end 240 of the outer collar 116 is in a non-expanded configuration and the proximal end 242 of the outer collar 116 is in an expanded configuration. The maximum perimeter 410 of the expanded outer collar 116 is at least slightly larger than the perimeter of the opening 118 to prevent pull-out.

The fastener 412 of FIG. 22 has external threads 414 configured to threadably engage the internal threads 148 of the inner member 114. As indicated by the arrow 418, the fastener 412 can be passed through a passageway 415 of the workpiece 417 and the passageway 220 of the inner member 114. Once the fastener 412 reaches the internal threads 148, the fastener 412 can be rotated with respect to the fixed inner member 114 until the fastener 412 is securely retained in the inner member 114, as shown in FIG. 23. Advantageously, the inner member 114 can be formed of a relatively strong material resulting in high pull-out resistance. For example, the inner member 114 can be made, in whole or in part, of steel, such as hardened stainless steel for enhanced thread strength. Conventional collapsible fasteners are made of a somewhat soft material and, consequently, are unsuitable for achieving high pull-out strengths, especially for retaining a threaded fastener. By contrast, the kit 110 has an outer collar 116 made of a somewhat compressible or expandable material, while the inner member 114 is made of a stronger material suitable for retaining the fastener 412 for a desired pull-out resistance.

If axial loads are applied to the installed kit 110, the outer collar 116 can withstand significant compressive loads without compromising its structural integrity. For example, high compressive loads (e.g., either static or dynamic cyclic loads) can be applied to the outer collar 116 via the tensioned fastener 412 if the inner member 114 is moved with respect to the expandable member 112. The outer collar 116 may withstand these loads without buckling or collapsing. By way of example, the outer collar 116 can resist tensile loads that would cause further collapsing of the flanges (i.e., the flanges formed via the collapsing process) in the threaded fasteners disclosed in U.S. Pat. No. 6,990,722. Because the compressed outer collar 116 maintains tensioning of the fastener 412, loosening of the fastener 412 can be reduced, limited, or substantially eliminated, thereby maintaining the clamp-up forces at or above a desired level. The amount of compression in the outer collar 116 can thus be selected to maintain the desired tensile pre-load in the fastener 412.

The proximal end 242 of the outer collar 116 of FIG. 23 can distribute the compressive stresses to the second side 382 of the workpiece 130. In some embodiments, the outer collar 116 provides generally uniformly distributed stresses (e.g., contact stresses) in the workpiece 130 to avoid unwanted high stresses that may damage the workpiece 130. For example, if the workpiece 130 is made of a composite material susceptible to cracking or delamination, the outer collar 116 can have a radial wall thickness sufficiently large to keep stresses in the workpiece 130 at or below an acceptable level to limit, reduce, or eliminate damage to the workpiece 130, even if the installed kit 110 experiences significant cyclic loading.

FIG. 24 is a graph that shows that radially expanding a thinner-walled expandable member 112, in contrast to a thicker-walled expandable member 112, may result in a higher amount of radial strain in the structural workpiece 130 during the expansion process combined with a higher amount of elastic spring-back of the expandable member 112 after expansion. Note that the graph of FIG. 24 illustrates the effect of radially expanding the expandable member 112 without any influence from the inner member 114. Curve 502 of FIG. 24 shows the amount of radial strain in the structural workpiece during cold expansion of the expandable member 112. Curve 504 shows that the amount of radial strain in the structural workpiece 130 is reduced after the thinner-walled expandable member 112 has had an opportunity to rebound or spring back.

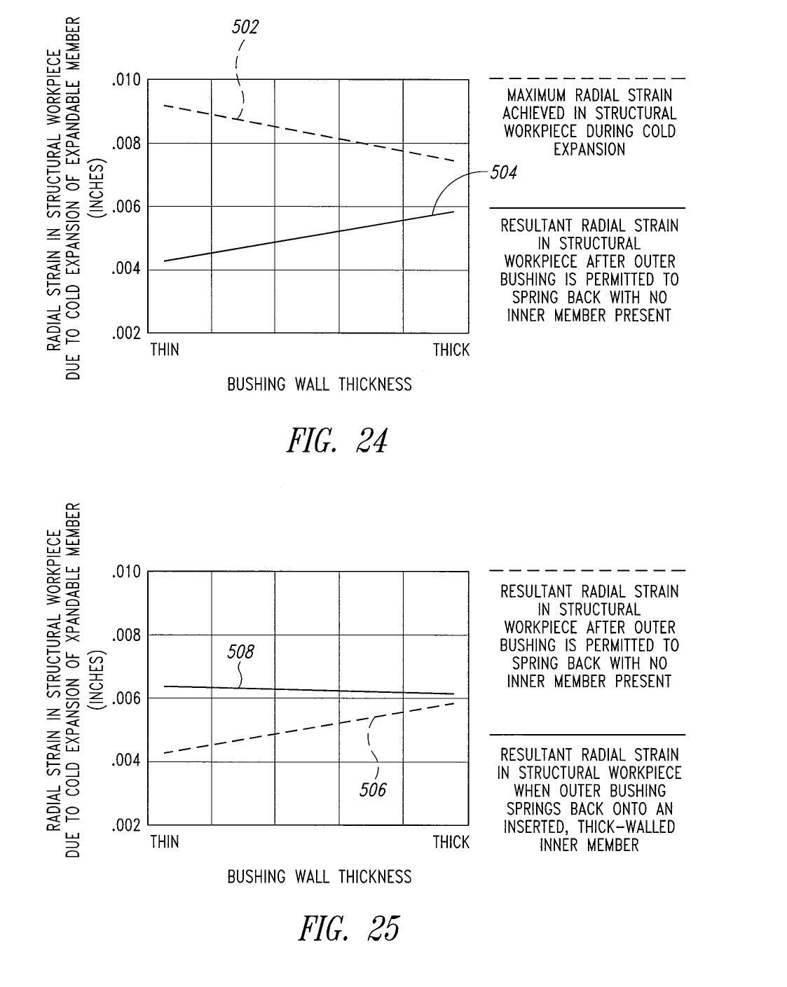

FIG. 25 is a graph that shows the radial strain in the structural workpiece 130 with the installation of both the expandable member 112 and the inner member 114 as compared to the installation of the expandable member 112 only. Curve 506 of FIG. 25 is the same as curve 504 of FIG. 24 and shows the resultant radial strain in the structural workpiece 130 if the expandable member 112 is permitted to spring back without an inner member 114 present. Curve 508 of FIG. 25 shows that the presence of a thick-walled inner member 114 within the member 112 reduces the amount of spring back of the expanded member 112, thus maintaining a higher amount of radial strain in the structural workpiece 130. In summary, the graph of FIG. 25 shows that the thicker walled inner member 114 is better able to react to the contact pressure of the expandable member 112, and in turn essentially props the expandable member 112 in the opening 118 of the structural workpiece 130 to maintain a higher amount of radial strain in the structural workpiece 130. Additionally, a high interference can be achieved without over-expanding the expandable member 112. The high interference can increase the pullout forces required to remove the assembled expandable member 112 and inner member 114.

In the preceding examples, the fatigue life enhancement is accomplished by the radial strain induced in the structural workpiece 130. In addition, the amount of spring-back of the expandable member 112 provides the interference fit between the components of the kit 110. In one embodiment, the desired amount of interference is sufficient to keep the inner member 114 from migrating under operation, vibration, and/or other types of loads, even if significant loads are applied via, for example, the fastener 412.

The kit 110 and installation process may be optimized by varying the relative thicknesses of the expandable member 112, inner member 114, and outer collar 116. For example, it may be desirable to obtain a higher level of expansion of a thinner expandable member 112 for the benefit of inducing a higher level of residual stress into the structural workpiece 130. Relatively large strains can be generated in the material of the workpiece 130 surrounding the installed member 112. In turn, this would also allow the expandable member 112 to “spring-back” by a greater amount and increase the relative interference between the inner member 114 and the expandable member 112. The size and properties (e.g., compressibility) of the inner member 114 can be selected for a desired amount of spring back, interference, and final tolerance of the installation.

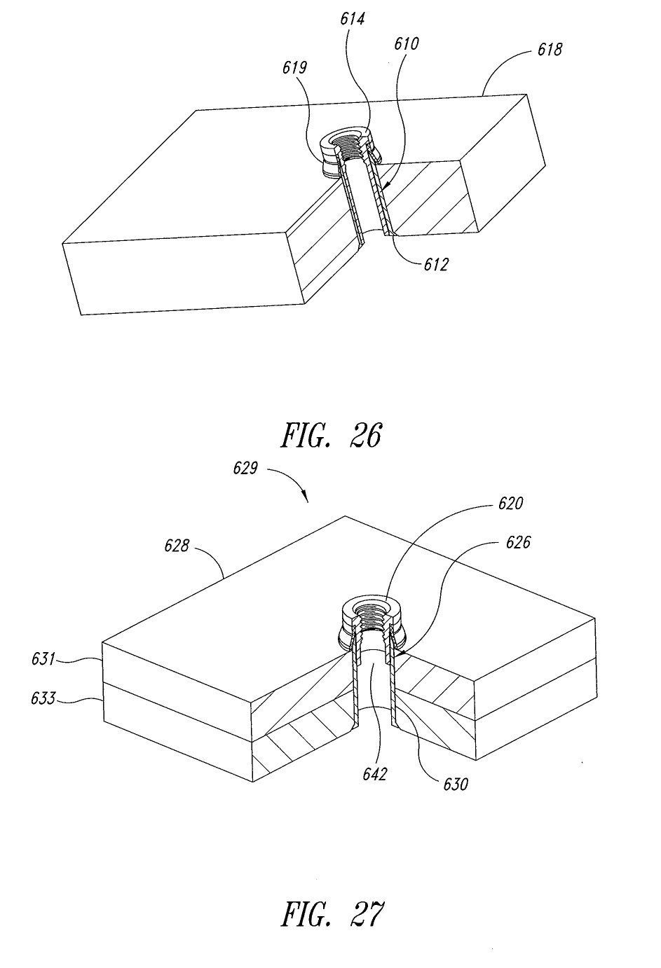

The kits can produce a wide range of fits, including high interference fits to low interference fits. A high interference kit, for example, can be configured for a high level of retention to, for example, reduce, limit, or substantially prevent migration of one or more of the installed components. Additionally, modular components of a kit can be mixed and matched to form installations suitable for a wide range of workpieces. For example, a standard length inner member 114 can be used with the expandable member 112, which is selected based on the thickness of the workpiece. This can reduce the part count for a kit and therefore reduces manufacturing costs of the kit. FIGS. 26 and 27 show installed modular kits with a standard inner member that can be used with an outer member dimensioned to match the thickness of the workpiece to achieve a selected fit (e.g., low or high interference fits).

With continued reference to FIG. 26, a relatively thick inner member 614 placed into an expandable member 612 to prop open and control the spring back of the expandable member 612. The receiving portion 610 of the inner member 614 extends along the longitudinal length of the expandable member 612. The amount of spring back of the expandable member 612 can be reduced to increase the interference between the member 612 and a workpiece 618. In some embodiments, the inner member 614 is a stout, thick-walled member that rigidly supports the radially-expanded expandable member 612. As noted above, the expandable member 612 tends to spring-back from its maximum expanded configuration during the expansion process to an unrestrained configuration (that is, the configuration of the outer bushing if the inner member is not present). The maximum expanded configuration and unrestrained configuration of the expandable member 612 define a maximum spring-back distance of the expandable member 612. The inner member 614 can limit spring back of the expandable member 612 to less than about 5%, 10%, 20%, or 30% of the maximum spring back distance. Thus, extremely high interferences can be obtained. Other amounts of spring back are also possible.

The stout inner member 614 can have a wall thickness that is substantially greater than the wall thickness of the expandable member 612. Additionally or alternatively, the inner member 614 can be made of a rigid material, for example, materials with a high modulus of elasticity. The inner member 614 can maintain its shape throughout and after the installation process to ensure that proper tolerances are achieved. The modulus of elasticity of the material forming the inner member 614 can also be greater than the modulus of elasticity of the deformable collar 619.

A low interference kit, when installed, can have a sufficient amount of interference to limit or substantially prevent unwanted migration with respect to the workpiece, while keeping strains in the workpiece at or below an acceptable level. FIG. 27 shows an inner member 620 that produces a low interference fit with an expandable member 626. A workpiece 620 in which the kit 629 is installed may be damaged when subjected to high strains.

The workpiece 628 of FIG. 27, for example, may comprise a composite material that is susceptible to damage due to high strains. The composite material can include, without limitation, reinforcing elements (e.g., fibers, particles, and the like), fillers, binders, matrix, or the like. Wood, fiberglass, polymers, plastics, metals, ceramics, glass, and the like can be combined to produce the workpiece 628 with properties that are different from the properties of its constituents individually. In some embodiments, the workpiece 628 can comprise a fiber-reinforced composite, particle-reinforced composite, laminate (e.g., a stack of laminas), or combinations thereof. The matrix of the reinforced composites can be made of metal, polymers, ceramics, or other suitable materials for encapsulating other reinforcement features. The laminates can be unidirectional laminates, cross-ply laminates, angle-ply laminates, symmetric laminates, or the like.

The kits can be installed in the opening of the composite workpiece, or other type of low strain workpiece, while maintaining the integrity of the workpiece. The expandable member 626, for example, can be easily inserted into an opening 630 of the workpiece 628. A mandrel can expand the expandable member 626 to form an interference fit with the workpiece 628. To minimize, limit, or substantially prevent damage to the material surrounding the opening 630, the amount of radial expansion can be below a threshold amount of expansion that would cause unwanted damage to the workpiece 628.

Composites may have relatively low strain capabilities as compared to metals. Expansion of the expandable member 626 can cause compressive loading in the composite material surrounding the opening 630. If the compressive loading is too high, fibers in a fiber-reinforced composite material can buckle, which in turn affects the material's properties. Micro-buckling of fibers may significantly reduce the water resistance of the composite material because buckled fibers may cause micro-cracking of the matrix surrounding the fibers. Splitting due to Poisson's ratio effect, matrix yielding, fiber splitting, debonding (e.g., fiber debonding, interlamina debonding, or the like), and other failure modes are often caused by compressive loading or high strains.

Advantageously, the kit can be installed using sufficiently low levels of strain to control the amount of damage, if any, to the workpiece 628. The expandable member 626, for example, can be installed with a slight interference fit, as well as other types of fits that keep the expandable member 626 in the opening 630 until the inner member 620 is installed. The expandable member 626 thus applies outwardly directed compressive forces to the workpiece 628 without compromising the structural integrity of the workpiece 628.

An end 642 of the inner member 620 can be located at a desired position along the expandable member 626. For example, the illustrated end 642 of the inner member 620 is positioned within the opening 630. Because the kit 629 of FIG. 27 can achieve high clamp-up forces, the kit 629 is especially well suited for use on multi-piece workpieces. The illustrated workpiece 628 is a pair of separate plates 631, 633. The kit 629 can apply high compressive forces sufficient to limit or substantially prevent unwanted separation or sliding of the plates 631, 633.

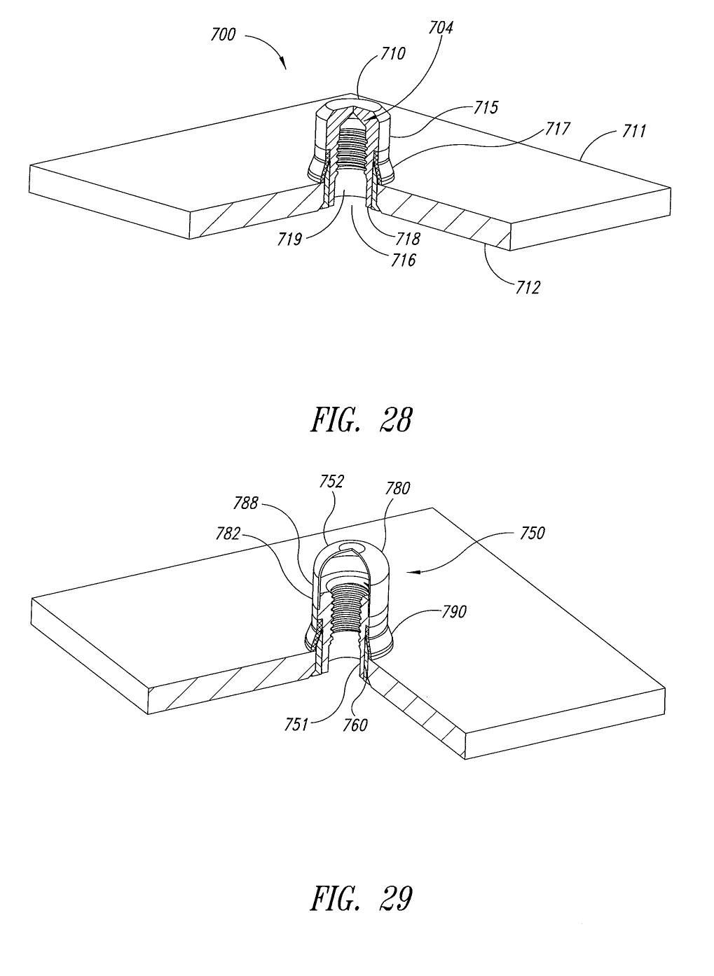

FIG. 28 shows an installed kit 700 with a one-piece inner member 704. The inner member 704 has an integrally formed closed-end 710 that can reduce, limit, or substantially prevent contaminates on the backside 711 of the workpiece 712 from entering the interior of the inner member 704, thereby preventing contamination of the kit 700. Additionally, the closed-end 710 can structurally reinforce the inner member 704 to enhance the overall structural rigidity of the kit 700. The illustrated closed-end 710 is proximate a shoulder 715 for contacting a collar 717 and opposes an open end 716. A passageway 719 of the inner member 704 extends between the closed end 710 and the open end 716.

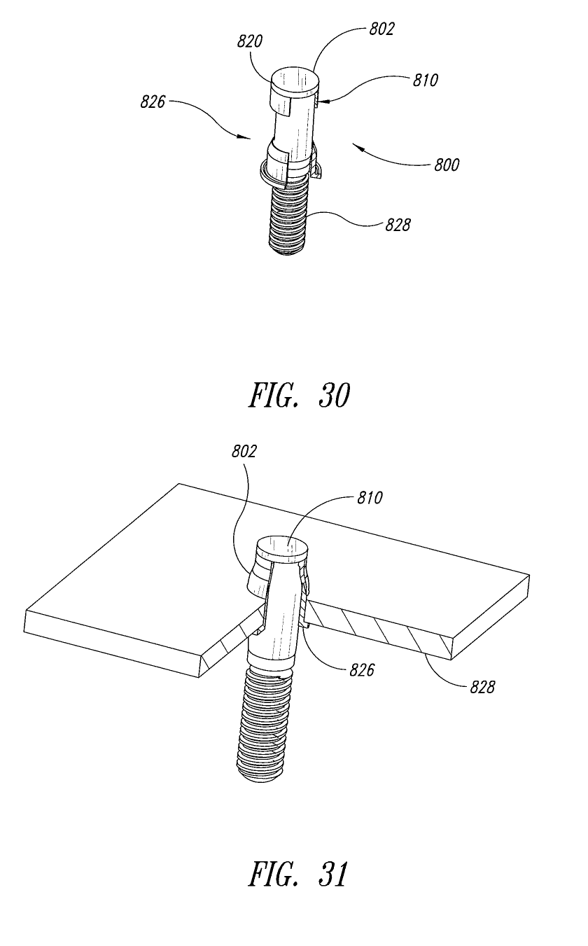

The inner members or collars described herein can also have a cap. FIG. 29 shows an inner member 750 including a main body 751 and a cap 752 attached to the main body 751. The main body 751 includes a receiving portion 760 at one end and a cap mounting portion 770 at the other end. The cap mounting portion 770 is configured to receive the illustrated cap 752.

The cap 752 can include a closed end 780, an open end 782, and a body 788 extending between the closed and open ends 780, 782. The illustrated cap 752 is a generally dome-shaped cap having a relatively thin sidewall. Caps having other shapes can also be used. The open end 782 can form a secure fit or other type of selected fit (e.g., fluid tight fit) with the inner member 751.

FIG. 30 shows a kit 800 that can be installed without utilizing a mandrel. The kit 800 includes an inner member 802 in the form of a threaded stud. A collar 810 (shown in cross-section) is positioned between a shoulder 820 of the inner member 802 and an expandable member 826 (shown in cross-section). A threaded region 828 of the inner member 802 projects outwardly past the expandable member 826 for conveniently connecting to an installation tool. For example, the threaded region 828 can be received by a puller gun which pulls the inner member 802 through the expandable member 826 until the inner member 800, collar 810, and expandable member 826 are coupled together in a workpiece 828, as shown in FIG. 31.

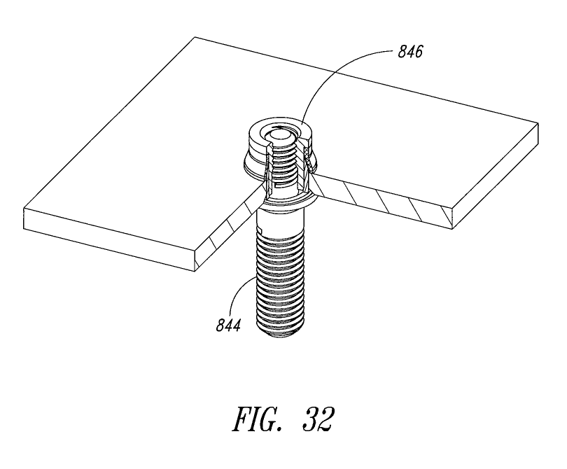

Various types of fasteners, studs, rods, and other types of installable components can be coupled to the installed kits. For example, FIG. 32 shows a stud 844 threaded into an installed inner member 846. The stud 844 can be removed, if needed or desired.

The kits described herein can be reused any number of times to couple a wide range of components to a workpiece. The kits can provide enhanced electrical conductivity through the workpiece, especially workpieces in the form of composite joints. The high clamp-up forces ensure that electrical contact is maintained during the service life of the workpiece.

The various embodiments described above can be combined to provide further embodiments. All of the above U.S. patents, patent applications and publications referred to in this specification, as well as U.S. Pat. Nos. 3,566,662; 3,892,121; 4,187,708; 4,423,619; 4,425,780; 4,471,643; 4,524,600; 4,557,033; 4,809,420; 4,885,829; 4,934,170; 5,083,363; 5,096,349; 5,405,228; 5,245,743; 5,103,548; 5,127,254; 5,305,627; 5,341,559; 5,380,136; and 5,433,100; and U.S. patent application Ser. Nos. 09/603,857; 10/726,809; 10/619,226; 10/633,294, and 11/653,196; and U.S. Provisional Patent Application No. 60/930,598 are incorporated herein by reference. Aspects can be modified, if necessary or desired, to employ devices, features, elements (e.g., fasteners, bushings, and other types of expandable members), and concepts of the various patents, applications, and publications to provide yet further embodiments. For example, the mandrel 301 of FIG. 4A can be used to install two or more expandable members disclosed in the incorporated patents, applications, and publications.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An installation in an opening in a workpiece, comprising:
an inner member having a shoulder and a receiving portion, the receiving portion having an outer surface;
an outer collar having a distal end, an expanded proximal end, and a body extending between the distal end and the proximal end, the body defining an inner surface of the outer collar, the distal end of the outer collar adjacent to the shoulder of the inner member, the proximal end of the outer collar adjacent to the workpiece, the body extending along the receiving portion of the inner member; and
an expanded bushing in the opening of the workpiece and interposed between the outer surface of the receiving portion and the inner surface of the outer collar, the expanded bushing comprising a distal expansion portion, a proximal retaining end, and a body extending between the distal expansion portion and the proximal retaining end, the distal expansion portion dimensioned to radially expand at least the proximal end of the outer collar in an initial configuration when the distal expansion portion travels between the inner surface of the outer collar and the outer surface of the receiving portion towards the shoulder such that the workpiece is captured between the expanded proximal end of the outer collar on one side of the workpiece and the proximal retaining end of the expanded bushing on another side of the workpiece.

2. The installation of claim 1 wherein the inner member includes an inner surface that defines a passageway, the inner surface of the inner member including engagement features configured to engage and retain a fastener positioned in the passageway.

3. The installation of claim 1, further comprising:
a fastener extending through a passageway of the inner member, the fastener including engagement features that mate with complementary engagement features of the inner member to translationally fix the fastener with respect to the inner member.

4. The installation of claim 1 wherein the expanded proximal end of the outer collar surrounds the opening in the workpiece and the distal end of the outer collar is in a non-expanded configuration.

5. The installation of claim 1 wherein the outer collar is translationally and rotationally fixed with respect to the expanded bushing because of expansion caused by the expanded bushing when the distal expansion portion between the inner surface of the outer collar and the outer surface of the receiving portion is moved towards the shoulder of the inner member.

6. The installation of claim 1 wherein the expanded bushing is a radially-expanded bushing translationally and rotationally fixed with respect to the workpiece due to compressive stresses developed in workpiece.

7. The installation of claim 1 wherein the expanded bushing is a radially-expanded bushing having a flange seated against the workpiece.

8. The installation of claim 1 wherein the shoulder of the inner member is an outwardly extending flange adjacent the receiving portion.

9. The installation of claim 1, further comprising:
a cap having a closed end and an open end opposing the closed end, the open end forming a secure fit with the body of the inner member.

10. The installation of claim 1 wherein the inner member has a closed end proximate the shoulder and an open end opposing the closed end, the open end defined by the receiving portion, wherein a component receiving passageway extends from the closed end through the open end.

11. The installation of claim 1, wherein the distal expansion portion extends outwardly from the workpiece.

12. A bushing system for installation in an opening of a workpiece, the system comprising:
a bushing kit comprising:
an inner member having a shoulder and a receiving portion;
an outer collar having a distal end, a proximal end, and a body extending between the distal end and the proximal end; and
a bushing dimensioned to be interposed between the receiving portion and the outer collar when the receiving portion extends through the outer collar, the bushing comprising a distal expansion portion, a proximal retaining end, and a body extending between the distal expansion portion and the proximal retaining end, the distal expansion portion is adapted to radially expand at least the proximal end of the outer collar when the distal expansion portion travels between the inner member and the outer collar towards the shoulder such that the workpiece is captured between the expanded proximal end of the outer collar and the proximal retaining end of the bushing.

13. The bushing system of claim 12, further comprising:
a mandrel coupleable to an installation tool operable to install the bushing kit, the mandrel comprising:
an engagement portion sized to cooperatively engage the installation tool;
a loading portion configured to receive and to retain the inner member; and
a bushing expansion portion between the engagement portion and the loading portion, the bushing expansion portion sized to radially expand the bushing as the bushing expansion portion passes through the bushing.

14. The bushing system of claim 13 wherein further comprising:
an installation tool coupleable to the engagement portion of the mandrel.

15. The bushing system of claim 12 wherein the inner member includes internal threads configured to engage and retain a fastener positioned in a passageway extending through the inner member.

16. The bushing system of claim 12 wherein the bushing includes a flange at the proximal retaining end.

17. The bushing system of claim 12 wherein the outer collar is adapted to be translationally and rotationally fixed with respect to the bushing because of radial expansion caused by the distal expansion portion of the bushing.

18. The bushing system of claim 12 wherein the inner member has a closed end proximate the shoulder, an open end opposing the closed end, and a component receiving passageway extending from the closed end through the open end.

19. The bushing system of claim 12, further comprising:
a cap having a closed end and an open end opposing the closed end, the open end adapted to form a secure fit with the inner member.

20. A method of installing a bushing kit into an opening in a structural workpiece, the opening extending between a first side and a second side of the workpiece, the method comprising:
positioning an inner member on the first side of the workpiece, the inner member comprising a receiving portion and a shoulder;
positioning an outer collar on the first side of the workpiece, the outer collar comprising a distal end, a proximal end, and a body extending between the distal end and the proximal end, the body of the outer collar surrounding the receiving portion of the inner member, the distal end of the outer collar adjacent to the shoulder of the inner member;
positioning an expander end of a bushing between the body of the outer collar and the receiving portion of the inner member such that the expander end is at the first side of the workpiece and a retaining end of the bushing is at the second side of the workpiece; and
after the expander end of the bushing is between the body of the outer collar and the receiving portion of the inner member and while the distal end of the outer collar abuts the shoulder of the inner member, moving the expander end of the bushing axially along the outer collar and the receiving portion of the inner member to radially expand at least the proximal end of the outer collar until the workpiece is secured between the expanded proximal end of the outer collar and the retaining end of the bushing.

21. The method of claim 20 wherein positioning the outer collar on the first side of the workpiece comprises moving the outer collar on the second side of the workpiece through the opening to the first side of the workpiece.

22. The method of claim 20, further comprising:
operating an installation tool coupled to an expansion mandrel extending through the bushing to radially expand the bushing before the expander end of the bushing is positioned between the outer collar and the inner member.

23. The method of claim 20, further comprising:
developing compressive stresses in the workpiece sufficient to alter fatigue performance of the workpiece by radially expanding the bushing in the opening.

24. The method of claim 20 wherein moving the expander end of the bushing causes the proximal end of the outer collar to slide over the expander end of the bushing.

25. The method of claim 20, further comprising:
compressing the workpiece between the expanded proximal end of the outer collar and the retaining end of the expandable member.

26. The method of claim 20 wherein moving the expander end of the bushing causes the proximal end of the outer collar to bulge outwardly.

27. The method of claim 20 wherein moving the expander end of the bushing induces cold radial expansion of at least the proximal end of the outer collar.
